(19) United States
(12) Patent Application Publication
(10) Pub. No.: US 2011/0183286 A1
(43) Pub. Date: Jul. 28, 2011

(54) HANDPIECE FOR DENTAL OR SURGICAL USE

(75) Inventor: Luc Maitre, Epauvillers (CH)

(73) Assignee: BIEN-AIR HOLDING S.A., Bienne 6 (CH)

(21) Appl. No.: 13/122,668

(22) PCT Filed: Oct. 6, 2009
(86) PCT No.: PCT/EP2009/062937

§ 371 Date: Apr. 5, 2011

(30) Foreign Application Priority Data
Oct. 7, 2008 (CH) 01598/08

(51) Int. Cl. A61C 1/12; B32B 1/08; B32B 27/04; B32B 27/38; A61C 1/08

(52) U.S. Cl. 433/82; 428/34.1

(57) ABSTRACT

Handpiece for dental or surgical use including fixed (2) components and moveable components, characterized in that at least some of said fixed (2) and/or moveable components are made from a composite material resulting from the association of at least two distinct basic materials, namely a matrix and a reinforcing agent, the composite material being deposited in one or several layers.

The present invention concerns a handpiece for dental or surgical use. More specifically, the present invention concerns an instrument of this type for dental or surgical use, wherein the body is made of a light, resistant material.

There are essentially two families of hand held instruments for dental or surgical use. The first of these families groups together what are called turbines, i.e. instruments whose tool, for example a bur, is coupled to a motor driven by compressed air. This type of motor can rotate at several hundreds of thousands of revolutions per minute with an air temperature typically on the order of 2.5 to 3 bars. The turbine includes a handle which enables the user to hold the instrument in his hand. The handle is conventionally connected to an electric power and fluid supply (air, water) unit via a connector and a flexible tube.

The second family of instruments for dental or surgical use groups together what are known as handpieces and contra-angles. Handpieces and contra-angles essentially differ in that the body of a handpiece is substantially straight while the contra-angle body forms an angle at some point on the length thereof. Otherwise, these two types of instruments are very similar. An electric motor, housed in the handle of the handpiece or contra-angle and capable of rotating at several tens of thousands of revolutions per minute, is connected via a tube with a fixed or rotating connector to the supply unit.

For the sake of convenience, the instruments for dental or surgical use described above will be referred to hereinafter by the generic term “handpiece”, in the knowledge that this term covers not just handpieces but also turbines and contra-angles.

Handpieces essentially comprise a handle which enables them to be hand-held and a head which carries the tool. These elements are conventionally manufactured from a brass or stainless steel bar. They have extremely complex external and internal shapes, which are expensive and time-consuming to machine (cutting, piercing, threading, stamping etc.) and require sophisticated machine-tools which may include up to eight different machine axes. Moreover, however sophisticated the machine-tools used, there is always a limit imposed by the shapes that these elements can be given.

It will also be noted that the materials used—brass or stainless steel—have advantages but also drawbacks. Brass, for example, is a material greatly appreciated by manufacturers because it is easy to machine. However, brass has the drawback of oxidising easily and thus has to undergo surface treatments via the deposition of layers of corrosion resistant materials. These relatively fragile layers tend to wear and scratch easily, and can expose the underlying brass layer in places, which gives users the impression that the instrument is of mediocre quality. Further, certain layers contain nickel, which, on contact, may cause users to develop allergies when these layers are exposed.

Conversely, stainless steel is, by definition, a material with good corrosion resistance and therefore does not require any specific treatment from this point of view. Moreover, stainless steel is lighter than brass and can thus allow producing handpieces that are less heavy in the user's hand, thus reducing the fatigue that the latter may feel after several hours of work. However, stainless steel has the drawback of being difficult to machine.

To overcome these problems, certain handpiece components (elements for connecting handpieces to the supply and control unit, insulating elements for electrical connectors, turbine blades etc.) have already been made by injecting plastic materials. Certain of the plastic materials used are biocompatible, which can allow producing components that will enter into contact with the user or patient. Moreover, the injection of plastic materials means that shapes are obtainable that would be difficult or impossible to obtain by machining brass or stainless steel pieces. The shapes that can be obtained by injecting a plastic material are, however, limited by the problems raised by removing the core or insert after the plastic material has cooled. For example, it would not be possible to remove the core from a part with a generally cylindrical shape, which would be bent locally. Moreover, the range of plastic material available to the manufacturer is very limited because of the lack of resistance of most of these materials to the sterilising cycles to which dental or surgical instruments are subjected. Finally, as a general rule, plastic materials do not enjoy a good image with users.

Whether the handpieces are made of brass or stainless steel or by injecting plastic material, they are perfectly rigid and thus transmit all of the vibrations generated during operation, which is tiring for the user and makes his movements imprecise.

There was therefore a need in the state of the art for a material that could combine the advantages of plastic materials (lightness, freedom as to shape, precision, repeatability and rapidity of injection) and metallic materials (longevity, mechanical resistance), and yet have properties of absorption for the vibrations generated by operation of the handpieces.

It is an object of the present invention to respond to this expectation by providing a handpiece for dental or surgical use including fixed components and moveable components, characterized in that at least some of these fixed and/or moveable components are made of a composite material resulting from the association of at least two distinct basic materials, namely an epoxy resin matrix and a reinforcing agent.

The matrix is obtained using an epoxy resin with two components and the reinforcing agent is selected from the group containing fibres or particles of carbon, glass, boron, kevlar, ceramic, aramid, nylon, steel or tungsten.

In a piece made of composite material, the epoxy resin matrix and reinforcing agent are placed in intimate contact on a macroscopic scale, the matrix giving the piece the desired shape and transmitting to the reinforcing agent (fibres or particles) the mechanical stresses to which said piece is subjected, which improves certain features of the reinforcing agent material.

A significant cause of fatigue in users of surgical or dental handpieces is connected to the vibrations generated by the operation of said handpieces. It has been realised that, in addition to being very resistant, epoxy resin handpiece handles have a degree of flexibility and are entirely able to absorb the vibrations generated by the operation of the handpieces. A handpiece fitted with this type of handle, for example made of carbon fibre, will thus vibrate less, which means the user gets less tired and makes more precise movements.

The fixed components of a surgical or dental handpiece include, in particular, the head and handle of such handpieces and the fixed or rotating connector parts for connecting the handpieces to a supply and control unit, better known simply as a “unit”. The moveable components include, amongst others, the turbine motors, the drivers and more generally the kinematic transmission chains for transmitting the motor torque to the tools and certain components of the handpieces or contra-angles.

Plastic materials appeared to open up promising perspectives within the field of manufacturing components for dental or surgical handpieces, but the limits of injecting such materials were very soon reached. Indeed, to be able to inject a plastic piece, on the one hand, a mould must be available to take the external shapes of the piece to be injected, and on the other hand, a rigid core or insert, which defines the internal shapes of said piece. After the plastic material has been injected into the volume left free between the mould and the core, the piece is cooled and removed from the mould and the core is taken out. It is this last step of removing the core which presents a problem. Indeed, it is not possible to envisage making pieces that have, for example, a reduced diameter or bent portion in places, since, in such case, it would not be possible to remove the rigid core after the piece has cooled. There is a need in the state of the art for handpieces with novelty shapes or ergonomic shapes which has not been satisfied to date, given that the shapes accessible by machining brass or stainless steel pieces or by plastic injection are essentially cylindrical shapes.

The present invention can overcome all of these limitations by teaching that surgical or dental handpiece components, such as heads or handles, can be made of epoxy resin. Indeed, the determining element in the technique of manufacturing epoxy resin components lies in the use of a core or insert made of a compressible material, such as silicon. More specifically, if one wishes, for example, to make a carbon fibre piece, the compressible core that defines the internal shapes of the piece to be made is covered in a carbon fibre mat or plaiting, then introduced into a mould which takes the external shapes of the piece to be manufactured. Epoxy resin is then introduced into the gap left free between the mould and the core and impregnates the carbon fibre. When the resin has hardened, the piece is taken out of the mould and the core is removed. Since the core is compressible, it can be deformed and thus pass without any difficulty over any point where the piece has, for example, a narrowed area or bent portion. Making handpiece components for surgical or dental use from a composite material thus eliminates almost all constraints in terms of the shape of the pieces to be made, and handpieces can thus be proposed with, for example, handles having novelty shapes or ergonomic handles that are easier to hold in the hand. It will be noted, however, that manufacturing a carbon fibre handpiece handle by means of the technique described above requires much more care and attention than manufacturing a handle, for example, by plastic injection. The step during which the core is coated in the carbon fibre mat or plaiting requires especially great care. Indeed, care must be taken to ensure that the carbon fibre mat matches the shapes of the core as closely as possible, so as to respect not only the internal geometry of the resulting piece, but also the thickness of the gap which separates the core coated in the mat from the mould and which determines the thickness of the resulting piece and thus conformity with the dimensions.

Making handpieces from composite material also allows weight savings to be made. Thus, for example, a handle made of brass which weights 14 g will weigh no more than 4 g when it is made of carbon fibre. A weight gain of 10 g is thus achieved, which represents a gain of around 15% on the total weight of an instrument, which is typically around 70 g. It will easily be understood that a lighter handpiece is less tiring for the user, who sometimes has to hold it in his hand for several hours a day.

The invention also concerns a core for implementing a method of manufacturing fixed and/or moveable components for a dental or surgical handpiece, said components being made from a composite material resulting from the association of at least two distinct basic materials, namely an epoxy resin matrix and a reinforcing agent. In said method, the core is introduced into a mould for moulding said components, and the core is characterized in that it includes receiving means in which one or several conduits will be housed, prior to moulding, for the air and/or water inlet and/or a light guide supplying light to the handpiece head. Preferably, the receiving means is grooves which will house, for example, conduits for the air and water supply, and a glass bar or optic fibre bundle for supplying light to the turbine head. As a result of this technique, pieces with very complex shapes can be made without any need to worry about how the various conduits and optical guides could be manually introduced into an equivalent handpiece made of brass of stainless steel. After the various conduits and light guides have been inserted into the grooves, the core is wrapped in a mat, for example, of carbon fibres, and the whole is then placed in the mould. The fibre mat is then impregnated by means of an epoxy resin which is allowed to harden, and then the piece is removed from the mould. The conduits and optical guides are then trapped in the resin.

Other features and advantages of the invention will appear more clearly from the following detailed description of an embodiment of the handpiece according to the invention, this example being given solely by way of non-limiting illustration with reference to the annexed drawing, in which:

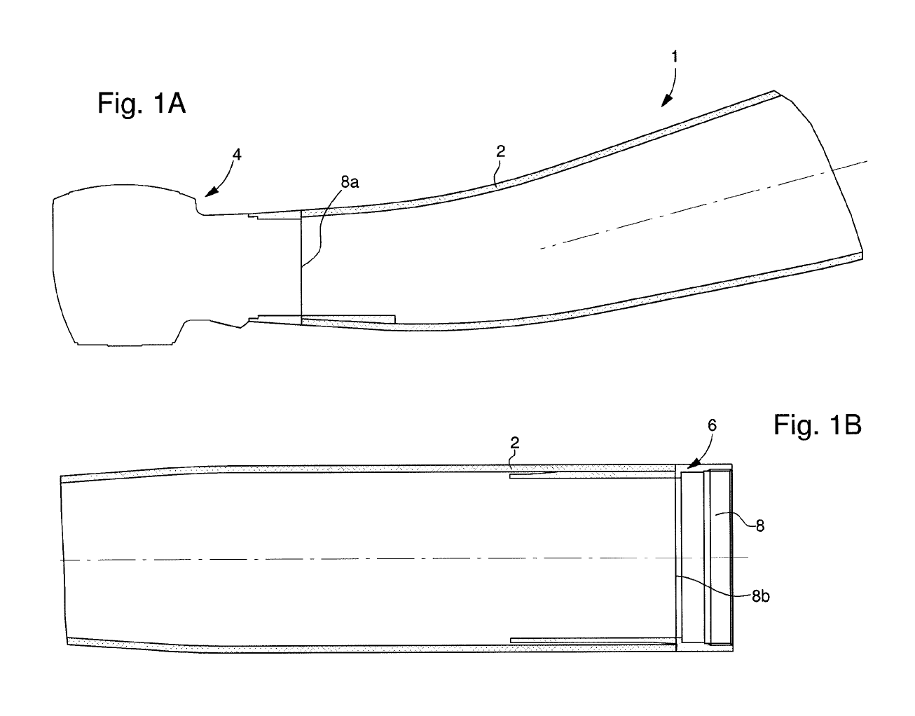

FIG. 1 is a cross-sectional view of a turbine type handpiece according to the present invention;

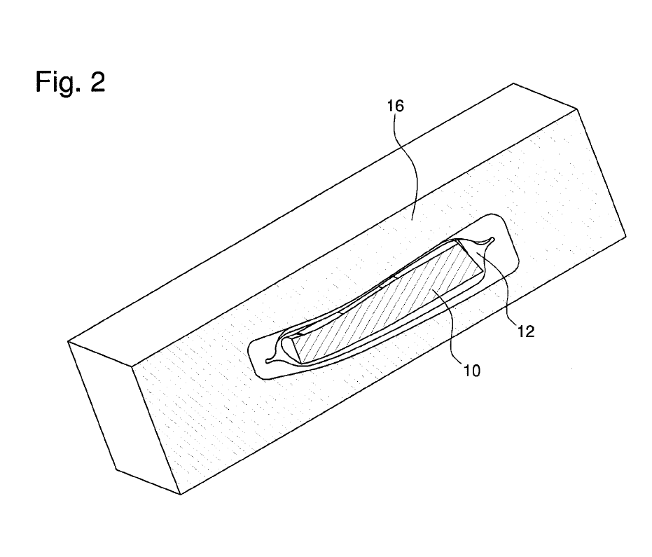

FIG. 2 shows a longitudinal cross-section of a mould illustrating the method of manufacturing a carbon fibre handle according to the invention;

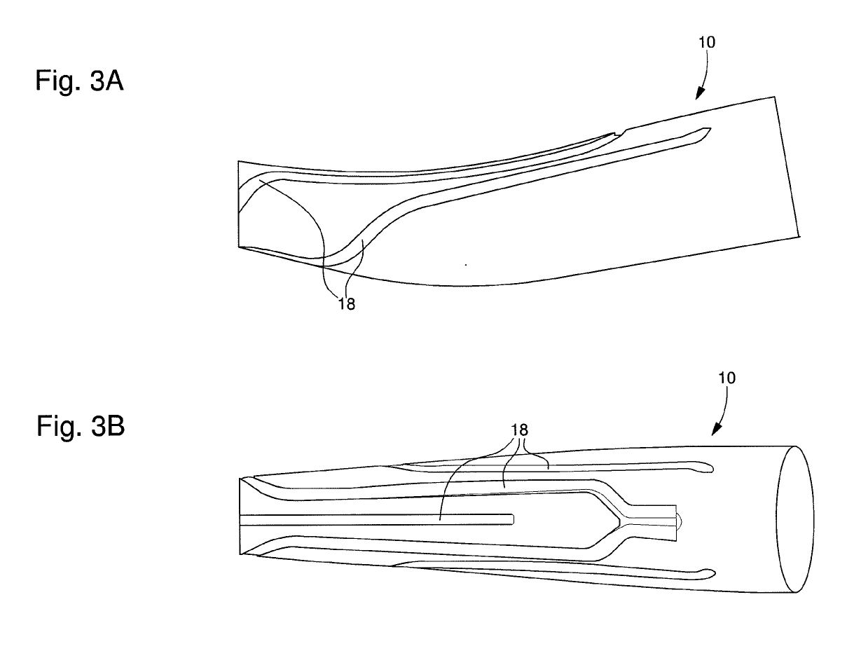

FIG. 3 is a perspective view of an alternative embodiment of a core for manufacturing a carbon fibre handle;

The present invention proceeds from the general inventive idea that consists in making at least some components of a handpiece for dental or surgical use from a composite material resulting from the association of at least two distinct basic materials, namely an epoxy resin matrix and a reinforcing agent. Most of the handpieces available on the market are made of brass or stainless steel, and very rarely by injecting a plastic material. These handpieces are perfectly rigid and thus transmit all of the vibrations generated during operation, which is tiring for the user and makes his movements imprecise. It was realised that handpiece handles made from epoxy resin have a degree of flexibility and are entirely capable of absorbing vibrations, which is more restful for the user and which enables him to improve the precision of his movements. Further, a handpiece wherein, for example, the handle is made of epoxy resin is more resistant and lighter. Finally, making a handpiece handle from epoxy resin means that novelty shapes can be produced, or ergonomic shapes making it easier to hold the handle in the hand. Indeed, the mould core or insert is made of a compressible elastomeric material, which means it can be removed after moulding, even if the handle has reductions in diameter or bent shapes in places, since the core will be able to be compressed, passing over areas of reduced diameter.

For the sake of clarity, the present invention will be described with reference to the embodiment of a handpiece handle for dental or surgical use made from carbon fibre impregnated with epoxy resin. It should, however, be understood that this example is given purely for non-limiting, illustrative purposes and that, according to a variant of the invention, this handle could be made in a similar manner using glass, boron, kevlar, ceramic, aramid, nylon, steel or tungsten fibres impregnated with epoxy resin. Likewise, according to another variant of the invention, the fixed and/or moveable components of a handpiece of the invention may be made using one or several layers of impregnated fibres.

FIG. 1 is a longitudinal cross-section of a turbine. Designated as a whole by the general reference number 1, this turbine includes a handle 2 made from carbon fibre to which there are connected a head 4 and a nozzle 6 for mounting a receptacle 8 to which a quick release coupling (not shown) will be connected for the supply of working fluids (air and water) and electricity. Head 4 and nozzle 6 could, for example, be made of stainless steel to contrast with the black colour of the carbon fibre and thus provide an advantageous aesthetic effect at ends 8a and 8b of handle 2 to which they are connected.

An example implementation of the method of manufacturing a carbon fibre handle according to the invention is given with reference to FIG. 2 annexed to this patent application. A core or insert 10, made from a compressible material such as silicon, and whose external shapes match the desired internal profile of the handle to be manufactured is covered in a carbon fibre mat 12. Core 10, thus wrapped in carbon fibre mat 12 is arranged inside a mould 16 whose inner surface matches the desired external shape of handle 2 to be manufactured. The thickness of carbon fibre mat 12 is typically three tenths of a millimetre and the play between core 10 and mould 16 is around a tenth of a millimetre. Thus an epoxy resin, which will impregnate carbon fibre mat 12, is moved into the empty space between core 10 and mould 16. It will be clear, that, for example, a glass or boron fibre mat may equally well be used instead of the carbon fibre mat.

When the epoxy resin has hardened, the part thereby obtained is removed from the mould. Since core 10 is compressible, it is able to deform to pass through places where handle 2 is bent or has a reduced diameter. The surface state of the handle 2 thereby obtained will depend upon the inner surface state of mould 16. If the inner surface of mould 16 has a mirror-polished state, the surface of handle 2 will be smooth and shiny. Conversely, if the inner surface of mould 16 has rough areas in places, the surface of handle 2 will have a rough, matt surface in corresponding places. These surfaces may, for example, define for the user areas where handle 2 can be gripped.

According to a variant of the invention, receiving means is provided on core 10, for example in the form of grooves which will house, for example, conduits for the air and water supply, and a glass bar or optical fibre bundle for supplying light to the head 4 of turbine 1. When the various conduits and optical guides have been inserted in grooves 18, the core 10 is fitted into carbon fibre mat 12. The conduits and light guides do not interfere with the engagement of carbon fibre mat 12 given that the latter can be stretched to up to two times its normal size. The series of subsequent operations is identical to that described above. Core 10 with its carbon fibre mat 12 is placed in a mould which is then closed. The fibres are impregnated with an epoxy resin which is allowed to harden, then the part is removed from the mould and cut to the desired shape and dimensions. Finally, the core is removed. The air and/or water conduits and the optical guide are trapped inside the epoxy resin. As a result of this technique, handpieces with very complex shapes can be manufactured without any need to worry about how the various conduits and optical guides could be manually inserted into an equivalent handpiece made of brass of stainless steel.

1.-6. (canceled)

7. A handpiece for dental or surgical use including fixed components and moveable components, wherein the fixed components include the head and the handle of said handpieces and the fixed or rotating connector parts for connecting said handpieces to a supply and control unit, at least some of the fixed components are made from a composite material resulting from the association of at least two distinct basic materials, namely an epoxy resin matrix and a reinforcing agent in the form of a carbon fibre mat, the composite material being deposited in one or several layers.

8. The handpiece according to claim 7, wherein the matrix is an epoxy resin with two components.

9. The handpiece according to claim 7, wherein the handle has smooth surfaces and matt surfaces.

10. The handpiece according to claim 8, wherein the handle has smooth surfaces and matt surfaces.

11. A core for implementing a method of manufacturing fixed and/or moveable components for a dental or surgical handpiece, said components being made from a composite material resulting from the association of at least two distinct basic materials, namely a matrix and a reinforcing agent, wherein the core is placed in a mould for moulding said components, and the core is wherein it includes receiving means in which one or several conduits will be housed, prior to moulding, for the air and/or water supply and/or a light guide supplying light to the head of the handpiece.

12. The core according to claim 11, wherein the receiving means is grooves.
